(19) United States
(12) Patent Application Publication
(10) Pub. No.: US 2026/0138557 A1
(43) Pub. Date: May 21, 2026

(54) BELT STRAP AND PRODUCTION METHOD FOR A SAFETY BELT HAVING ELECTRICALLY CONDUCTIVE CONDUCTING TRACKS, AND BELT STRAP ASSEMBLY HAVING A FUNCTIONAL ELEMENT

(71) Applicant: JOYSON SAFETY SYSTEMS GERMANY GMBH, Aschaffenburg (DE)

(72) Inventors: Lukas SCHOLZ, Berlin (DE); István SZABÓ, Kazincbarcika (HU)

(21) Appl. No.: 19/118,221

(22) PCT Filed: Sep. 22, 2023
(86) PCT No.: PCT/DE2023/200199

§ 371 Date: Apr. 3, 2025

(30) Foreign Application Priority Data
Oct. 19, 2022 (DE) 10 2022 127 602.3

(51) Int. Cl. B60R 22/12; D03D 1/00; D03D 15/533

(52) U.S. Cl. CPC B60R 22/12; D03D 1/0005; D03D 15/533; D10B 2401/16; D10B 2505/122

(57) ABSTRACT

The invention relates to a webbing, a manufacturing method and a webbing arrangement for a safety belt with electrically conductive conductor tracks and contact points on a surface of the webbing, which are provided for a conductive connection of at least one single functional element to the conductor tracks.

The invention is characterized in that the conductor tracks in a first section extend essentially in a longitudinal direction of the webbing and—at least in the intended arrangement area of the functional element—are arranged between the surfaces of the webbing wherein the conductor tracks in a separate second section extend at an angle transverse to those of the first section or at an angle transverse to the longitudinal direction and the contact points are formed on at least one of the surfaces.

The invention relates to a webbing for a safety belt with electrically conductive conductor tracks according to claim 1, a manufacturing method for such a webbing according to claim 7 and a webbing arrangement with a functional element according to claim 10.

From prior art, e.g. publication DE 10 2014 004 960A1, webbings for a safety belt are known which have electrically conductive conductor threads which are integrated or woven into the webbing and extend essentially along a longitudinal direction of the webbing. It is also known that functional elements can be fixed to such a webbing and are integrated into the electrical circuit.

The conductor threads or tracks integrated or woven into the safety belt are crucial for the longevity of the electrical system, the durability of which would be impaired if they were installed on a surface of the safety belt. Due to constant stress, for example if the safety belt is guided past a deflection device such as a D-ring or a buckle of a belt fastening element, these would quickly wear out due to direct contact with other objects and thus become inoperable. For this reason, it can be advantageous to place the conductor threads or conductor tracks between the surfaces of the webbing in order to avoid direct contact with the other objects.

For an electrically conductive connection or an electrical contact of the conductor threads to a functional element, which is generally an electrical consumer and has therefore to be integrated into the circuit, the solutions according to the state of the art provide relatively complex designs. In this case, it can be provided that a contact surface for the connection of the functional element is created on a surface of the webbing, whereby in order to connect the functional element to the circuit, it only has to be placed on the contact surfaces.

According to the current state of the art, the creation of contact surfaces on the surface of the webbing is very complicated, costly and time-consuming. For example, it can be provided that the conductor threads integrated or woven into the webbing are pulled to the surface with a special tool in order to form the contact surfaces and create suitable connection points for the conductive connection. For example, it is known that the integrated conductor threads are grasped with a hook and then brought to the surface, where they form the contact points. The contact points therefore form a uniform system with the integrated conductor threads. These are therefore not to be viewed as separate.

A resulting object of the invention is to improve the manufacturing process for a generic webbing, in particular to make it more efficient and cost-effective.

This object is achieved by a webbing according to claim 1, a manufacturing method for a webbing according to claim 7 and a webbing arrangement according to claim 10. The respective dependent subclaims form advantageous embodiments of the invention.

Accordingly, a generic webbing for a safety belt of a vehicle has electrically conductive conductor tracks with contact points on at least one of the surfaces of the webbing, which are provided for a conductive connection of at least one single functional element to the conductor tracks.

According to the invention, the webbing has several sections in which the conductor tracks extend, each section being to be interpreted as a separate section, since the conductor tracks are not firmly connected to one another at the transitions between two sections, as the conductor tracks are, for example, within a single section, but merely touch one another, lie against one another or make electrical contact and thus create a conductive connection.

Accordingly, it is provided that the conductor tracks in the first section extend essentially along a longitudinal direction of the webbing and-at least in the intended arrangement area of the functional element-are arranged between the surfaces of the webbing. An arrangement between the two surfaces of the webbing provides that they do not form any exit or contact with the surfaces.

The surfaces of the webbing are to be interpreted as the side of the webbing that is usually in contact with the body of a vehicle occupant and the side of the webbing opposite to this. The conductor tracks of the second section extend from the conductor tracks of the first section, which are to be considered separate from those of the first section and form the contact points for connecting the functional element on at least one of the surfaces. The conductor tracks of the second section extend at an angle transverse to those of the first section, i.e. in the direction of one or both surfaces, as defined in the paragraph above.

In particular, the separate design of the two sections of the conductor tracks makes it possible to create a contact point on the surface of the webbing at any point along the longitudinal direction in an uncomplicated manner. In particular, this makes it possible to create a contact point on the surface mechanically and easily.

The manufacturing method according to the invention for a webbing with electrically conductive conductor tracks and contact points on a surface of the webbing essentially consists of the following steps:
providing a webbing which has conductor tracks in the first section which are arranged—at least in the intended arrangement area of the functional element between the surfaces of the webbing and extend along a longitudinal direction of the webbing; and
the conductor tracks in the second section are then created by introducing them at an angle transverse to those of the first section or an angle transverse to the longitudinal direction of the webbing, wherein they at least partially touch or electrically contact the conductor tracks of the first section and the contact points are formed on at least one of the surfaces.

Here too, the conductor tracks of the second section are created separately from those of the first section. The conductor tracks of the first and second sections contact each other electrically and are not firmly connected to each other—i.e. inseparably in the sense of a destructive connection in which the conductor thread must be cut through.

This is preferably achieved by a thread insertion device, such as a sewing needle, working the conductor threads or conductor tracks of the second section into the webbing and penetrating into the webbing at least far enough that they can electrically contact the conductor tracks of the first section extending in the longitudinal direction of the webbing. The conductor tracks of the second section are preferably guided from the first to the second surface side, offset there and guided back in the opposite direction.

The conductor tracks, both in the first and in the second section, can comprise one or more conductive threads, so-called conductor threads. The conductor threads are always electrically conductive and can be partially or completely insulated.

In particular, the conductor tracks or conductor threads of the first section are woven into the webbing, shot in and/or extend in a channel along the longitudinal direction of the webbing.

Preferably, the conductor threads or conductor tracks of the second section are incorporated into the webbing by introducing a seam, in particular a zig-zag seam. The conductor threads are thus introduced into the webbing at an angle to the first surface of the webbing, preferably until they penetrate the opposite second surface of the webbing. An offset then takes place, in which the conductor thread is guided back at a distance from the exit opening in order to finally exit again at the first surface. In a further pass, i.e. insertion at the first and exit at the second surface and the whole thing in the opposite direction, an offset with a distance takes place again.

The distance between two entry openings on the respective surface should depend on the cross-section of the conductor track of the first section and on the number of planned punctures. Tests have surprisingly shown that the probability of electrical contact between a conductor thread of the second section and the conductor track of the first section is greatest when the distance is chosen to be between one and six times the conductor track cross-section of the first section. Preferably, however, between one and three times the conductor track cross-section.

When offsetting the conductor tracks when working the conductor thread into the webbing several times, this should be done at an acute or obtuse angle across the length of the webbing. In order to keep the probability of the conductor tracks of the first section touching those of the second section as high as possible, the angle should be around 45°.

The angle at which the conductor thread of the second section is inserted into the webbing, which is preferably done by the sewing needle, is preferably 90° to the surface of the webbing. However, this angle can also be varied, for example between 75° and 105°.

Another main claim is to protect a webbing arrangement which in particular has a webbing according to one of the previously mentioned embodiments. A functional element is placed on the contact points of the webbing and fixed to it or is otherwise conductively connected to the conductor tracks of the webbing. The functional element must be integrated into the electrical circuit in order for it to function properly.

The functional element can be fixed to the webbing, for example, by means of a material-locking connection, such as welding, vulcanization or gluing, or by means of a form-fitting connection. When selecting the material-locking connection, attention must be paid to an appropriate material combination of webbing and functional element, or more precisely its adhesive layer, which is intended for fixing to the webbing. The selection of the material combination must ensure that the two materials can be connected using the appropriate process.

The material-locking process involves connecting one of the top sides of the webbing to the bottom side of the functional element—or its adhesive layer. In contrast to a form-fitting connection, such as fixing using a mandrel, which is carried out both through the material layer of the webbing and through the material layer of the functional element—or its adhesive layer—the fixing using the material-locking process is only surface-related, i.e. there is no damage to the material. This design represents a twist lock with regard to the functional element on the webbing, which also prevents unwanted penetration of contaminants, such as dust particles or moisture, into the functional element or between the contact areas.

A particularly preferred embodiment is the so-called laser welding process. The functional element is brought into contact with the webbing and then the two contact surfaces are melted using a laser and a focusing unit and connected to one another in a force-conducting manner under the influence of a certain pressing force.

Another preferred variant is the so-called ultrasonic welding process. The functional element is brought into contact with the webbing and then connected to one another in a force-conducting manner using a high-frequency vibration generator under the influence of a certain pressing force. The connection is made in a location-specific manner, i.e. the connection described is created wherever the vibration generator is attached.

Both versions are particularly cost-efficient and implement all the described advantages of the material-bonding process.

The functional unit is a consumer in the form of a sensor, actuator and/or a lighting unit. In the last embodiment, an LED or an LED lighting unit is to be used in particular.

The invention is explained in more detail below using an embodiment with reference to the figures. They show:

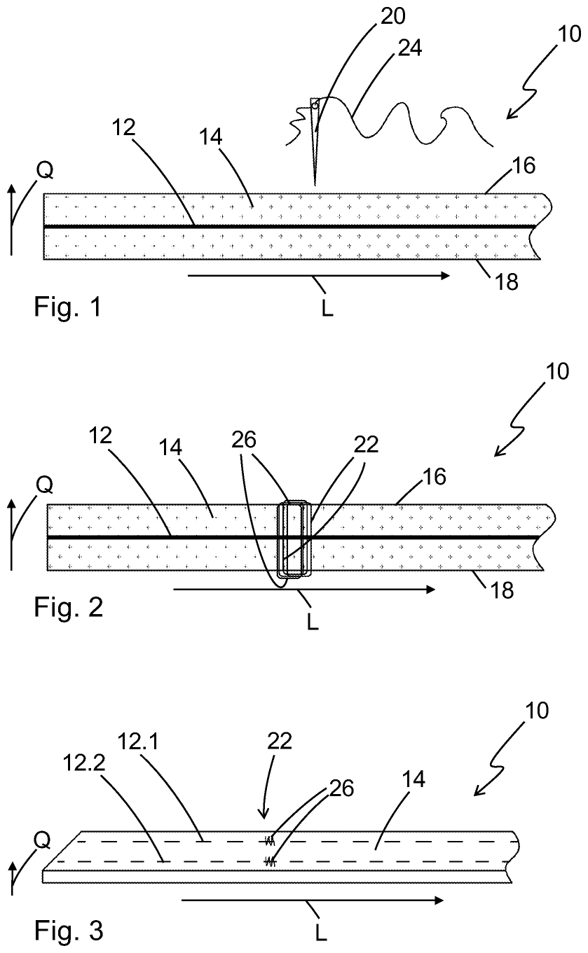

FIG. 1 a side view of a longitudinal section of the webbing according to the invention with incorporated conductor tracks according to the first section;

FIG. 2 the object according to FIG. 1 with additionally incorporated conductor tracks according to the second section;

FIG. 3 a perspective view of the object according to FIG. 2;

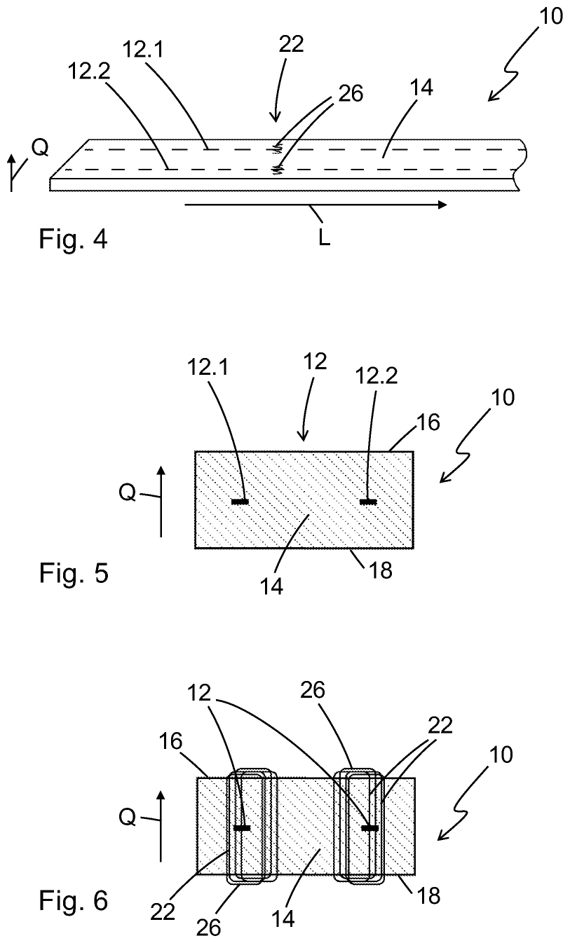

FIG. 4 a perspective view of the object according to FIG. 2 in a further embodiment;

FIG. 5 a front view of a cross section of the object according to FIG. 1;

FIG. 6 a front view of a cross section of the object according to FIG. 2;

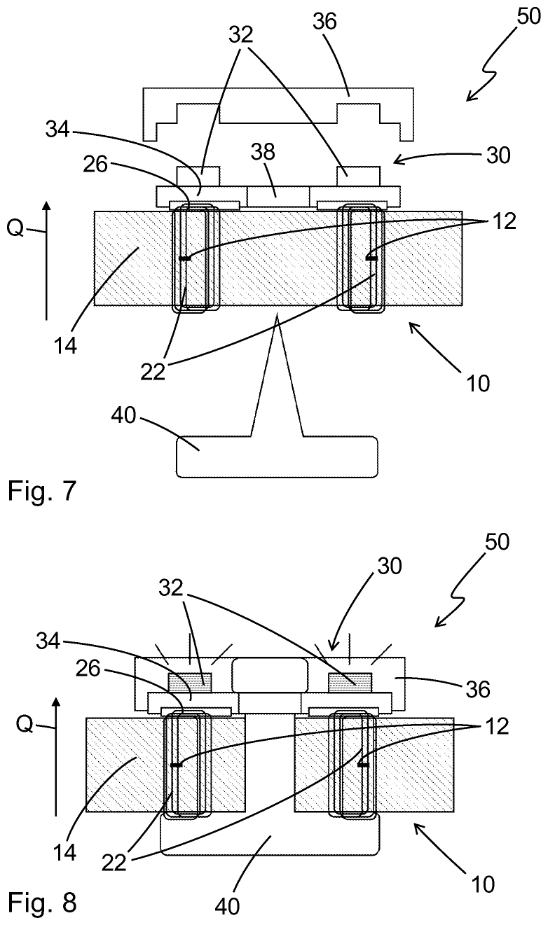

FIG. 7 a front view of a cross section of the object according to FIG. 2, wherein a functional element is arranged for fixation; and

FIG. 8 the object according to FIG. 7, wherein the functional element is fixed.

FIG. 1 shows a side view of a longitudinal section of a webbing 10. Electrically conductive conductor tracks 12 extend along a longitudinal direction L of the webbing 10 in a first section. It can be seen that the conductor tracks 12 extend within a webbing fabric 14 and are thus arranged between the two surfaces 16, 18 of the webbing 10. This is the case at least in the area of an intended arrangement of a functional element 30 on the webbing 10.

In this case, the webbing surfaces 16, 18 are to be interpreted as the surface 16 of the webbing 10 which lies against the body of the vehicle occupant in a normal state of use of the webbing, and the surface 18 of the webbing 10 which lies opposite this surface 16.

In addition, a conductor insertion device 20 is visible, which is designed to incorporate conductor tracks 22 of a second section (see FIG. 2) into the webbing fabric 14. The conductor tracks 22 of the second section are in particular conductor threads 24. The conductor insertion device 20 is in turn in particular a sewing needle. The conductor tracks 22 of the second section form contact points 26 on the surface 16, 18 of the webbing 10, which are provided for a conductive connection of at least one single functional element 30 (see FIGS. 7 and 8) to the conductor tracks 12, 22.

According to the invention, the conductor tracks 22 of the second section are arranged separately from the conductor tracks 12 of the first section and also extend at an angle Q transverse to those of the first section. Viewed in a side view-as shown in FIG. 1, for example—the conductor tracks 12 of the first section extend in the horizontal longitudinal direction L, while the conductor tracks 22 of the second section are arranged vertically, i.e. in the transverse direction Q. Alternatively, the conductor tracks 22 of the second section extend at an angle transverse Q to the longitudinal direction L of the webbing 10. In addition, the two conductor tracks 12, 22 are in electrical contact with each other. Electric current should be able to be conducted between the two sections. Separately defined in this case is that the two conductor tracks 12, 22 are not inseparably connected to each other, i.e. do not form a fixed unit with each other.

According to the invention, this is achieved by means of a manufacturing method in which, in a first step, a webbing 10 is provided which include the conductor tracks 12 in the first section, wherein these extend substantially in the longitudinal direction L, are arranged within the webbing fabric 14, and/or extend between the two surfaces 16, 18 of the webbing 10.

In a second step, the conductor tracks 22 of the second section are incorporated into the webbing 10 or the webbing fabric 14. This is preferably done by means of the conductor insertion device 20, which inserts the conductor thread 24. The insertion of the conductor tracks 22 in a second step enables the aforementioned separate embodiment and also solves the problem according to the invention. It is essential that the two conductor tracks 12, 22 are electronically contacted with one another.

FIG. 2 shows that the conductor tracks 22 are incorporated several times into the webbing fabric 14. This is not absolutely necessary, but increases the probability that the conductive contact between the two conductor tracks 12, 22 is actually created.

FIG. 3 shows the above-mentioned object in a perspective view. It can be seen that within the webbing fabric 14 there is a conductor track 12 of the first section and an associated conductor track 22 of the second section. These run at a distance and parallel to one another and are designated with the reference numerals 12.1 and 12.2. Each conductor track 12 of the first section is assigned to a conductor track 22 of the second section. Both conductor tracks 12, 22 form an electrical circuit together with the functional element 30. The two conductor tracks 12, 22 are electrically contacted.

For this purpose, there is a power source that is connected to the conductor tracks 12, 22. The power source is preferably arranged in an area of the webbing 10 that, when mounted, is arranged within a vehicle near an end fitting, i.e. the end of the webbing that is not pulled into a retractor. The circuit is therefore closed by integrating the functional element 30 as a load.

FIG. 3 also shows the contact points 26. Here it can be seen that these are incorporated into the webbing fabric 14 in the form of a seam, in particular in the form of a zigzag seam. The course of the seam extends along the longitudinal direction L, with the conductor track 12 extending between two adjacent punctures of the conductor tracks 22 in the surface 16. This increases the probability that the electrical contact of at least one conductor thread 24 with the conductor track 12 is achieved.

The choice of the angle of penetration into the surface 16 of the webbing 10 is preferably 90° to the surface plane, i.e. essentially transverse Q to the longitudinal direction L of the webbing 10, as shown in the figures.

The distance between two adjacent puncture holes of the conductor threads 24 on the surface 16 preferably corresponds to the simple cross section of a conductor track 12 of the first section and/or is dependent on a diameter of the conductor insertion device 20 or the sewing needle.

FIG. 4 shows an alternative embodiment in which the seam is rotated by 90° to the seam in FIG. 3. This can be advantageous if a geometry of the conductor tracks 12 of the first section changes. A geometry of the conductor tracks 12 of the first section can be circular, square or rectangular, for example. Depending on this, it may be necessary to adapt the seam of the conductor track 22.

FIG. 5 shows an example of the front view of a cross-section through the webbing 10, in which only the conductor tracks 12.1 and 12.2 of the first section are introduced.

In contrast, FIG. 6 also shows a front view of the cross section of the webbing 10, but in this case the conductor tracks 22 of the second section are located in the area of the cross section. It is also clear that at least one single conductor track 22—among the plurality of conductor tracks 22—forms an electrical contact with those of the first section 12. It is also clear that a plurality of individual conductor tracks 22 on the surfaces 16, 18 of the webbing 10 each form a bead, which forms the contact points 26 for an electrical connection of the functional element 30.

FIG. 7 shows an exemplary view of the webbing arrangement 50 according to the invention. It can be seen that a functional element 30 with a circuit board 34 is in electrical contact with the two contact points 26 of the webbing 10. The functional element 30 is, for example, circular and has a central opening 38. At least one lighting unit 32 in the form of an LED is arranged on the top side of the circuit board 34. Using the described circuit, it is possible to control or activate the functional element(s) 30 depending on the situation. In the embodiment shown, the functional element 30 is fixed to the webbing 10, for example, by means of a mandrel 40. The mandrel 40 has a tip for assembly, which is guided through the webbing fabric 14 for fixing and is inserted into the opening 38 of the functional element 30. In an end position, the tip of the mandrel 40 is then deformed or a corresponding counterpart is placed on the tip so that the functional element 30 is permanently fixed to the webbing 10. The pressing force of the mandrel 40 on the functional element 30 and the webbing is generally selected in such a way that the functional element 30 is secured against rotation, so that the functional element 30 cannot accidentally rotate about an axis in the fixed state.

According to an alternative embodiment, the mandrel 40 is arranged on the cover 36, so that during assembly the mandrel 40 is guided from the side of the functional element 30 through the webbing 10 in the direction of the opposite surface 18 and is fixed on this side. The fixing can be carried out analogously to the embodiment according to the parent paragraph. This embodiment therefore represents the opposite case, whereby the cover 36 and the mandrel 40 are advantageously a single component, which improves assembly.

Additionally or alternatively, the anti-twisting feature can be achieved by means of (additional) fixing by gluing, welding or sewing. The first two embodiments have the additional advantage that the circuit board 34 or the functional element 30 is prevented from unwanted penetration of particles, such as moisture or dirt, between the contact area and the webbing 10.

The anti-twisting feature can be achieved additionally or alternatively by using a second mandrel for fixation.

The functional element 30 has a cover 36 on its upper side, which also serves as a diffuser for the light rays of the lighting unit 32.

### LIST OF REFERENCE SYMBOLS

10 webbing
12 conductor tracks of the first section
14 webbing fabric
16 surface
18 surface
20 conductor insertion device/sewing needle
22 conductor tracks of the first section
24 conductor threads
26 contact points
30 functional element
32 LED/lighting unit
34 circuit board
36 cover/diffuser
38 opening
40 mandrel
50 webbing arrangement
L longitudinal direction
Q transverse direction

1. A webbing for a safety belt, the webbing comprising:
a first surface;
a second surface opposite the first surface;
electrically conductive conductor tracks; and
contact points positioned on at least one of the first surface or the second surface of the webbing, and configured to provide a conductive connection of at least one single functional element to the conductor tracks,
wherein the conductor tracks in a first section extend essentially in a longitudinal direction of the webbing and—at least in an intended arrangement region of the functional element—are arranged between the first surface and the second surface of the webbing, and
wherein the conductor tracks in a separate second section extend at an angle transverse to those of the first section or at an angle transverse to the longitudinal direction.

2. The webbing according to claim 1, wherein the conductor tracks of the second section have conductor threads which are preferably worked into the webbing with a sewing needle and at least partially electrically contact the conductor tracks of the first section.

3. The webbing according to claim 2, wherein the conductor threads are incorporated into the webbing several times at a distance from one another, whereas the distance is between one and three times a width of the conductor tracks of the first section.

4. The webbing according to claim 2, wherein the conductor threads are incorporated into the webbing several times offset from one another, whereas the offset extending at an acute or obtuse angle transversely to the longitudinal direction of the webbing.

5. The webbing according to claim 4, wherein the angle is substantially between 75° and 105°.

6. The webbing according to claim 1, wherein the conductor tracks of the first section and/or the second section comprise conductor threads or conductive threads and are woven or shot into the webbing.

7. A manufacturing method for a webbing of a safety belt with electrically conductive conductor tracks and contact points on a surface of the webbing, which are provided for a conductive connection of at least one single functional element to the conductor tracks, comprising the following steps:
providing a webbing which has first conductor tracks in a first section which—at least in an intended arrangement area of the functional element—are arranged between first and second surfaces of the webbing and extend along a longitudinal direction of the webbing; and
producing second conductor tracks in a second section by introducing them at an angle transverse to those of the first section or at an angle transverse to the longitudinal direction,
wherein the second conductor tracks at least partially electrically contact the first conductor tracks and the contact points are formed on at least one of the first surface or the second surface.

8. The manufacturing method according to claim 7, wherein the second conductor tracks are introduced by means of a sewing needle.

9. The manufacturing method according to claim 7, wherein the second conductor tracks are sewn in by means of a zigzag seam.

10. The webbing according to claim 1, wherein the functional element is placed on the contact points webbing and fixed thereto.

11. The webbing according to claim 1, wherein the functional element comprises a sensor, an actuator or a lighting unit.

12. The webbing according to claim 10, wherein the fixing of the functional element to the webbing is carried out by means of a mandrel, by gluing, welding, ultrasonic welding, laser welding, or sewing.

13. The webbing according to claim 1, wherein an anti-twist device is attached to the functional element.

14. The webbing according to claim 1, wherein the functional element creates an elevation on the first surface or the second surface of the webbing that differs from the rest of the webbing surface,
the webbing further comprising a webbing deflection device having a contour or notch corresponding to the elevation created by the functional element so that the functional element can slide through the webbing deflection device without damage.

15. The webbing according to claim 1, wherein the functional element includes a lighting unit comprising is an LED.

16. The webbing according to claim 5, wherein the angle is 90°.
